(19) United States
(12) Patent Application Publication
(10) Pub. No.: US 2012/0325647 A1
(43) Pub. Date: Dec. 27, 2012

(54) Methods for Increasing the Kinetic Activity of Water and Other Liquids, so as to Render the Liquids More Useful in Enhancing the Alternative Cellular Energy Pathway and in Various Other Agricultural and Industrial Applications

(76) Inventor: William John Martin, South Pasadena, CA (US)

(21) Appl. No.: 13/166,800

(22) Filed: Jun. 22, 2011

(51) Int. Cl. C01B 5/00; B01J 19/12

(52) U.S. Cl. 204/157.5; 422/186.3

(57) ABSTRACT

A method for energizing water and other liquids is described. It is based on previous studies showing the use of ultraviolet (UV) light illuminated of alcohol containing neutral red dye as a means of activating the alternative cellular energy (ACE) pathway. Rather than directly activating the patient, the method's ACE pathway, it is used to activate water and liquids for drinking by the patients. Once activated, a liquid can further activate a larger volume of liquid by simply being added to the larger volume of liquid. The methods should find widespread application in human, animal, agricultural and industrial uses of water and other liquids.

### CROSS REFERENCE TO RELATED APPLICATIONS

### Co-Pending Patent Application

Methods for Detection of Ultraviolet Light Reactive Alternative Cellular Energy Pigments (ACE-pigments) William John Martin Submitted Dec. 24, 2007. Publication number 20090163831

Method of assessing and of activating the alternative cellular energy (ACE) pathway in the Therapy of Diseases. William John Martin Submitted Jan. 16, 2008.

Publication number 20090181467

Enerceutical mediated activation of the alternative cellular energy (ACE) pathway in the therapy of diseases. Submitted May 8, 2008. Publication number 20090280193

Enerceutical activation of the alternative cellular energy (ACE) pathway in therapy of diseases. Submitted Feb. 11, 2009. Publication number 20090202442

Method of using the body's alternative cellular energy pigments (ACE-pigments) in the therapy of diseases Submitted Feb. 20, 2009. Publication number 20100215763

Urine as a source of alternative cellular energy pigments (ACE-pigments) in the assessment and therapy of diseases. Submitted Mar. 5, 2009. Publication number 20100196297

Diagnostic value of systemic ACE pathway activation in the detection by fluorescence of localized pathological lesions. Submitted Jul. 26, 2010. Publication number 20100291000

Enerceutical mediated activation of the alternative cellular energy (ACE) pathway in the therapy of diseases. Submitted July 2010.

Energy Charged Liquids to Enhance Enerceutical Activation of the Alternative Cellular Energy (ACE) Pathway in the Therapy of Diseases. Submitted Dec. 17, 2010.

Application Ser. No. 12/972,344

Energy Charged Alcoholic Beverages for Enhancing the Alternative Cellular Energy Pathway in the Prevention and Therapy of Diseases. Submitted January 2011.

### Application Number

Methods for Detecting and Monitoring the Activity of Energized Water and Other Liquids Useful for Enhancing the Alternative Cellular Energy Pathway in the Prevention and Therapy of Diseases. Submitted February 2011

Methods for Increasing the Kinetic Activity of Alcohol, Water and Other Liquids, so as to Render the Liquids More Useful in Enhancing the Alternative Cellular Energy Pathway in the Prevention and Therapy of Diseases. Submitted February 2011

### STATEMENT REGARDING FEDERALLY SPONSORED RESEARCH OR DEVELOPMENT

Not applicable: No Federal funding was received in support of this patent application.

### REFERENCE TO SEQUENCE LISTING, A TABLE OR A COMPUTER PROGRAM LISTING COMPACT DISK APPENDIX

Not applicable.

### BACKGROUND OF THE INVENTION

In recently submitted co-pending patent applications, which are incorporated by reference herein, I disclosed that the passage of electrolytically derived Water Gas (otherwise known as Brown's Gas) into alcohol (200 proof absolute ethanol) greatly enhances the ability of the alcohol to react with neutral red dye and with alternative cellular energy (ACE) pigments (defined in the co-pending patent applications). When a small number (usually around 10) of neutral red dye particles (obtained directly from a commercially available neutral red dye powder e.g. Dudley Corp. N.J.), are gently sprinkled onto a plastic dish, which contains Water Gas “charged” alcohol, there is rapid and vigorous dissolving of most of the material within the neutral red dyes particles. This occurs in a directional manner forming long, narrow red streams of dissolved neutral red. Equally impressive, fine particles, breaking away from the larger particles of neutral red dye, which remain non-dissolved in the alcohol solution, undergo continuing to-and-fro movements, with apparent attractive forces rapidly alternating with repulsive forces. The linearity of the dissolving neutral red and the dynamic movements of non-dissolved particles occur in regular (non-charged) absolute alcohol, but are greatly heightened by Water Gas charging of the alcohol. The use of charged alcohol also significantly enhances the intensity of the orange fluorescence of the neutral red solution, when compared with dye dissolved in non-charged alcohol. As the alcohol (both charged and non-charged) finally evaporates, the precipitating neutral red dye assumes attractive, banded circular patterns, as if being influenced by an interactive energy field. The patterns are more striking using charged alcohol. The charged alcohol also shows greater interaction than does non-charged alcohol with ACE pigments collected from the saliva and/or perspiration of virus infected patients. When used therapeutically, as described in co-pending patent applications, the combination of neutral red with charged alcohol is decidedly more effective in enhancing the ACE pathway in energy deficient individuals, when compared with, still quite impressive, benefits obtained using untreated (non-charged) alcohol.

The linear dissolving pattern of neutral red dye observed in alcohol solutions, was also observed in various alcoholic beverages, especially when they were charged with Water Gas. This extraordinary pattern is not ordinarily seen when neutral red dye is added to ordinary (non-charged) water in similar plastic dishes. Instead, slowly dissolving neutral red particles become gradually surrounded by the dissolved dye in essentially concentric discs of red dye. An exception is seen with some plastic drinking glasses and some plastic covered paper cups. In these containers, there is an obvious attraction between the plastic material and the neutral red particles, leading to radial movements of the particles towards the interface between the surface of the water and the plastic container. (These types of containers are, therefore, unsuitable for used in the experiments described in this application). I have commonly used small (1.5″) square individual polycarbonate dishes and various multi-well tissue culture dishes. The dishes are generally observed using a low power, dissecting microscope with spacing between the light and the dish to help reduce heat transfer. In some experiments light emitting diode (LED) illumination was used to exclude heat, as opposed to light, as the cause of particle movements.

An important finding was observed when neutral red dye particles, are gently sprinkled (scattered) onto a plastic dish of distilled water, and the dish is placed in close proximity to a dish of charged alcohol with moving neutral red dye particles. Instead of the particles in the water remaining essentially stationary and only slowly dissolving, several of the particles will begin to move throughout the water. Moreover, if additional neutral red dye is added, the fresh particles will show more linear dissolving patterns with movements of the remaining non-dissolved particles. The energy transference effect is best seen when the dishes are in direct contact or comprise adjacent wells within the same multi-well dish. Physical contact is not absolutely necessary, however, and the effect has been seen between separated dishes. I, thereby, discovered that the altered dissolving pattern of neutral red dye in ordinary water potentially provided a simple assay for detecting a radiating energy coming from the well containing the charged alcohol and neutral red particles. The assay also provides a means of detecting the water and alcohol energizing capacities of various additional forms of energy, in addition to that provided by Water Gas. For convenience, this assay will be subsequently referred to as the “NR-Kinetic Assay.”

Specifically, the present patent application extends on the finding that a charged alcohol containing solution of neutral red, provides a very efficient method of transferring a dynamic activity, expressed using the NR-Kinetic Assay, and other measures, as explained herein, to water and other liquids. Charging of the alcohol solution is generally achieved using a combination of votexing followed by bubbling of water gas. Further optimization, as assessed by the NR-Kinetic Assay, can potentially be achieved using sound energy of approximately 500 Hz, electromagnetic, magnetic and electrostatic energies, and by the addition of magnesium chloride. Of special interest is that the indirectly activated water and other liquids have now been shown to be able to transfer quite striking NR-Kinetic Assay activity to added additional liquids, including water.

The charged alcohol plus dissolved neutral red dye method was primarily developed to activate the ACE pathway in humans and animals. The newer findings provide additional approaches to this goal, such as drinking and bathing in dynamically activated water, and using such water in the cultivation of edible foods. Various industrial applications of dynamically activated water can also be inferred from other studies and are also becoming apparent from ongoing research.

### BRIEF SUMMARY OF THE INVENTION

The NR-Kinetic assay was used to demonstrate easily discernable increased dynamic activity in water and alcoholic beverages in which a container of alcohol and NR dye, is partially submerged and illuminated with a UV light. The water and alcoholic beverage retain the enhanced dynamic activity after removal of the container and can be used to further activate other fluids, by either addition to the liquid or by being placed in close proximity to the liquid. The level of activation of water in which the container of alcohol and neutral red dye is placed, is enhanced by prior charging of the alcohol by magnetic vortexing and bubbling of Water Gas before adding neutral red dye. The indirectly activated water not only shows markedly heightened activity in the NR-Kinetic Assay, but the resulting solution can fluoresce with UV illumination. Moreover, the NR containing, indirectly activated water, can be used to create NR-Kinetic Activity in other liquids placed in close proximity. Indirectly activated water, without neutral red, has been consumed and used for bathing, including

### BRIEF DESCRIPTION OF THE DRAWINGS

Not Applicable and none included

### DETAILED DESCRIPTION OF THE INVENTION

The NR-Kinetic Assay has previously been employed in the direct assessment of various kinds of processed liquids, including absolute alcohol and alcoholic beverages. For instance, it was also used to demonstrate the marked effect of simply bubbling Water Gas through absolute alcohol on the ability of the “charged” alcohol to react with neutral red dye. Not only was there more of a direct effect on neutral red added to the Water Gas charged alcohol, such as more intense fluorescence, but the light illuminated charged alcohol solution containing neutral red dye, was clearly able to distantly induce movements of non-dissolved neutral red dye particles placed in an adjacent well containing regular water. In this assay, the light illuminated neutral red dye containing charged alcohol was placed in one of the wells of a tissue culture plate. Adjacent wells contained water plus stationary un-dissolved neutral red dye particles. These wells were observed microscopically to see whether any of the non-dissolved neutral red particles would begin to move, which they did beginning approximately 30-60 seconds later. An additional observation on the adjacent neutral red dye in water wells included the occasional formation of numerous gas bubbles, which might well represent the formation of Water Gas. The energy transference type of assay consistently provided positive results, which were not seen using multiple wells in other culture dishes, which simply had water plus neutral red solutions.

These studies prompted interest in whether the indirectly activated water may have beneficial properties, beyond those of ordinary water. Additionally, studies were undertaken to compare the indirectly activated water with waters with claimed therapeutic benefits, including the well water from Bheau View Ranch in San Marcos Calif., water through which Water Gas had been bubbled and water exposed to variously processed volcanic rock-derived materials. The later were chosen because of my reasoning that the reasons for certain aquifers may be providing more “energized” waters is exposure to forces present within materials in the earth's crust. Some of these materials can be delivered to the earth's surface via volcanic eruptions. Moreover, these types of materials have been used in a wide range of animal husbandry, agricultural and industrial applications with apparent benefit.

Water from the well at the Bheau View Ranch, San Marcos, Calif. was tested using the NR-Kinetic Assay and shown to have discernable activity. A Ziploc bag containing 30 ml of absolute alcohol (ethanol, Sigma Aldrich), which had been vortexed for 3 minutes using a magnetic stirrer (Jura-Capresso Inc. model 202, Milk frother) followed by bubbling of a mixture of hydrogen, oxygen, air and Water Gas (generated from a Brown' Gas Electrolyzer, advertized on www.watertogas.com, as a way of enhancing automobile fuel economy). The 1 pint (essentially 500 ml) closed jar uses six overlapping washers, alternatively linked to the anode and the cathode of a 4.5 volt power supply, delivering 500 m Amps. Water containing approximately 10 gm of either citric acid or sodium bicarbonate, as the electrolyte, is added to the jar, prior to connecting the electrodes. A small aquarium air pump at 2.2 Watt (Whisper) is used to transfer the evolving hydrogen, oxygen and Water Gar from the jar into the alcohol solution using plastic tubing. Bubbling of the gas is allowed to proceed for 30 minutes, allowing for some evaporation of alcohol, but with sufficient left to proceed with the experiment. Thirty ml (essentially 1 oz) of the charged alcohol are added to a Ziploc bag with the further addition of approximately 15 mg of neutral red powder. The Ziploc bag is further sealed using heat and is then available for various uses, including the activation of other liquids. (The same solution preparation procedure is commonly used, with UV illumination, to activate the ACE pathway in individuals by either taping the Ziploc bag onto the sole of a foot (as practiced by the mother of an adolescent child with autism), placed into the open mouth of adults with systemic deficiencies in their ACE pathway, or placed onto sites of previously occurring recurrent herpes simplex virus (HSV) induced skin lesions. The UV light is generally provided via a 13 Watt Halco spiral lamp or if unavailable a UV fluorescent tube, using UV protective goggles.)

For water activation, the Ziploc bag is inserted into a partially filled glass containing the water and exposed from above to the UV light. The fluid within the Ziploc bag shows a bright orange fluorescence. At varying times, a small aliquot of the water from the glass is examined microscopically using the NR-Kinetic Assay. This type of study showed the rapid and intense activation of the water, which actually showed fluorescence with the dissolving and dynamically moving neutral red. Using this approach, marked enhancements of the dynamic activity of the Bheau View Ranch water, regular tap water, various bottled waters and to these waters which were further exposed to bubbled Water Gas using the watertogas apparatus (www.watertogas.com) and/or to volcanic rock-derived materials, including Stirwands (www.stirwandsdirect.com) and so called Kiko Stones (www.kikotechnology.com).

The striking positive dynamic activity enhancing results obtained by placing UV illuminated charged alcohol with neutral red dye solution, into water, was confirmed using other beverages, including alcoholic drinks, fruits and vegetable juices, milk and soft drinks While issues such as increased viscosity of some of the liquids and decreased solubility of neutral red dye limited the usefulness of the NR-Kinetic Assay, the sense was gained of each drink acquiring dynamic energy from the UV illuminated neutral red dye in alcohol solution.

Ongoing studies are based on determining if drinking the energized liquids can provide clinical benefits beyond that of drinking comparable amounts of the same liquids in their non-energized form. Assistance with such studies has been requested from the mother of a child with autism and from other individuals. Preliminary findings are encouraging. For example, the mother of the autistic child has used the procedure to charge both water and V8 vegetable juice. She definitely discerned clearer pronunciation and more complete sentence formation by her daughter. The mother is extending the study by noting changes in intra-oral UV fluorescence of her child as a result of the energized drinks Similar studies are ongoing in another ACE pathway deficient individual now regularly drinking energized beverages.

Other potential therapeutic applications under consideration are using energized water in footbaths, regular bath water, spas, cosmetic formulations, humidifiers, etc. The results, to date, argue that neutral red or other suitable dye, with appropriate illumination, leads to a better distant transmission of the activating energy, without the need for contiguous liquid. In other words, a footbath of energized water has not yet proven to be effective, as compared to using the UV illumination of neutral red containing alcohol in a Ziploc bag that is attached to the sole of the patient's foot. Drinking of indirectly energized liquids, has, however, produced clinical benefits in a human and would presumably also do so in animals.

Over the last several years, I have been well aware of the potential animal husbandry and agricultural applications of various water treating devices and additives. A major goal of animal husbandry is to enhance growth rate and minimize illness in farmed animals, including cows, pigs, sheep and fish. For edible crops, the emphasis is on growth rate, along with taste and shelf life. Cut flowers are mainly judged on their color and how long they survive. Farmers have been introduced to approaches of improving their water. The methods include i) applying a vortex spin to water; ii) passing water through electric, magnetic and electromagnetic fields; sound energy; iii) addition of volcanic and heated ceramic stones, etc. There are reasonably consistent reports that these various approaches can be at least, somewhat advantageous when applied to farming.

Energized water is also reported as having benefits in various industrial applications, including inhibiting and even reversing rust corrosion in metal pipes in cooling towers, boilers, etc. Energized water is also said to have improved cleansing properties, requiring less soap.

At least, based on the NR-Kinetic Assay results, the UV illuminated charged alcohol with neutral red dye method is likely to be superior to these alternative approaches in these various agricultural and industrial applications. Moreover, as previous shown and confirmed using the new format, it is possible to utilize sunlight as the source of UV light in the energy transfer from a charged alcohol:neutral red solution to either a patient or a glass of water.

The intriguing finding of a beneficial effect of treated liquids extending to larger volumes of liquids to which it is directed added or diluted by also does not require the use of a UV light. The mechanism by which the smaller volume of liquid can affect a larger volume of water is consistent with a resonance effect, not unlike the ability of a ringing tuning fork to stimulate the ringing of other tuning forks of the same frequency.

The principles, preferred embodiments and modes of operation of the present invention, intended to be protected herein, is not to be construed as limited to the use of only treated alcohols, since regular alcohol (ethanol) can also be used, although somewhat less effectively. Similarly, the present patent application is not restricted to the use of neutral red as the primary receiver of the UV, or even regular light energy. Other dyes are currently under evaluation, including acridine orange and methyl violet. Neutral red has the advantage, however, of having been used in therapeutic endeavors, aimed at activating the body's ACE pathway. The term “energized” is also not meant to be exclusive of other relevant terms, which I or other investigators may use in furthering the research described in this application. An operational alternative term being used is E3 water, which stands for etheric energy expanded water.

Additional modifications of the basic tenets disclosed in the present patent application will readily occur to those skilled in the art and especially upon practicing the currently described methods. For example, kits can be devised, which comprise a battery driven UV light and a sealed compartment for the alcohol plus added neutral red dye. The light can be turned on and the kit submerged into a water pond for growing rice, or a swimming pool, etc. A UV illuminated, liquid containing device can be attached to piping that is not necessarily transparent to the fluorescent component. The kits can also comprise previously activated water or other liquids, which can be subsequently diluted into a larger volume of liquid. The quantitative volume and time limitations of such approaches can be monitored using the NR-Kinetic Assay.

1. A method of directly providing energy to water, comprising placing into the water, a sealed plastic bag or other suitable container, in which there is sufficient ethanol plus freshly added neutral red dye, so that when the container is directly illuminated with ultraviolet (UV), its contents will fluoresce and then leaving the UV illuminated container within the water for sufficient time, such that if a few particles of neutral red dye are sprinkled onto the surface of a removed aliquot of the water, the dissolving particles will rapidly form clearly discernable linear streaks of dye, rather than more slowly developing circular concentrations of dissolving dye, as would normally be seen in an aliquot of the water prior to the energizing process.

2. The method of claim 1, in which the alcohol is previously exposed to one or more methods to enhance its own interaction with neutral red dye, such methods including the use of a vortex, with or without a spinning magnet, and/or the bubbling through the solution of electrolytically generated Water Gas (Brown's Gas).

3. The method of claim 1, in which liquids, other than regular water, are being energized by the alcohol:neutral red dye containing solution; such liquids include but not limited to tea, coffee, alcoholic beverages, milk, fruit and vegetable juices, soft drinks.

4. The method of claim 1 in which natural sunlight is used as the source of ultraviolet (UV) radiation.

5. The method of claim 1 in which a dye other than neutral red, but with comparable water energizing properties, is used instead of neutral red.

6. The method of claim 1 in which a solution other than ethanol, but with comparable water energizing properties is used instead of ethanol

7. A method of energizing a relatively large volume of water, comprising the addition of a considerably smaller quantity of previously energized water, produced by using the method of claim 1, such that following the addition of the energized water, the larger volume of water will show evidence of being energized, including that if a few particles of neutral red dye are sprinkled onto the surface of a removed aliquot of the water, the dissolving particles will rapidly form clearly discernable linear streaks of dye, rather than more slowly developing circular concentrations of dissolving dye, as would normally be seen in an aliquot of the water prior to the energizing process.

8. A method of claim 7 in which liquids, other than water, is used as either or both the larger volume of liquid to be energized or the smaller volume of previously energized liquid to be diluted within the larger volume of liquid.

9. A kit comprising a battery driven ultraviolet light attached to a compartment into which ethanol or other suitable liquid can be placed with the further addition of neutral red dye or other suitable dye, such that when the kit is assembled it is waterproof and can be submerged into water or other liquids to be energized.
